(19) United States
(12) Patent Application Publication
(10) Pub. No.: US 2018/0103582 A1
(43) Pub. Date: Apr. 19, 2018

(54) WHEELED STRING TRIMMER MOWER

(71) Applicant: MAT ENGINE TECHNOLOGIES, LLC, Long Grove, IL (US)

(72) Inventors: Edwin Charles SELF, Columbia, TN (US); Jason Dale LEWIS, Huntingdon, TN (US); Jeremy Douglas LEASURE, Lexington, TN (US); Gregory Kevin GRIFFIN, Humboldt, TN (US)

(21) Appl. No.: 15/842,143

(22) Filed: Dec. 14, 2017

Related U.S. Application Data
(63) Continuation-in-part of application No. 15/658,982, filed on Jul. 25, 2017.
(60) Provisional application No. 62/368,034, filed on Jul. 28, 2016.

(51) Int. Cl. A01D 34/68; A01D 42/00; A01D 34/416; A01D 34/82; A01D 34/84

(52) U.S. Cl. CPC A01D 34/68; A01D 42/00; A01D 2101/00; A01D 34/824; A01D 34/84; A01D 34/4166

(57) ABSTRACT

A trimmer head for a string trimmer mower, including a trimmer head housing having a string retention portion and a coupler portion rotatably attached to the string retention portion, the string retention portion having a first string retainer for releasably retaining a first cutting string. In addition, the string retention portion has a second string retainer for releasably retaining a second cutting string. The second string retainer is preferably circumferentially displaced on the string retention portion from the first string retainer. In a preferred embodiment, the first string retainer has a slidable clamp disposed in the interior and accessible from the exterior. The clamp is constructed and arranged for sliding relative to the base between a clamping position for selectively retaining the string in place through centrifugal force in the string retention portion, and a release position for user replacement of the first cutting string without tools.

### RELATED APPLICATION

This application is a Continuation-In-Part of U.S. patent application Ser. No. 15/658,982 filed Jul. 25, 2017, which is a Non-Provisional of, and claims 35 USC 119 priority from, U.S. Patent Application No. 62/368,034 filed Jul. 28, 2016, both of which are incorporated by reference herein.

### BACKGROUND

The present invention relates generally to lawn and grass trimming machines, and in particular, to a wheeled string trimmer mower.

Many conventional wheeled string trimmers only cut what is directly underneath the machine, between a pair of wheels. When it is desired to cut grass or weeds near walled corners, underneath or adjacent fences, including rail type fences, or other obstructions, due to the relation between positions of the two wheels, the trimmer head cannot adequately access the corners or other hard to reach places.

Another drawback of conventional string trimmers is that when edging is desired, such as along a driveway or sidewalk, it is relatively difficult to manipulate existing string trimmers units to achieve an even cut appearance.

In addition, another drawback of conventional handheld string trimmers is that they do not have the ability to evenly mow areas of grass left behind by larger equipment, such as a riding lawn mower.

Thus, there is a need for an improved string trimmer mower that addresses the above-listed operational difficulties of conventional string trimmers.

### SUMMARY

The above-listed drawbacks of conventional trimmers are addressed by the present string trimmer mower featuring a string retention mechanism for releasably retaining a cutting string that accommodates multiple string diameters and also provides for string replacement without the use of tools. Another feature of the present trimmer is a pivoting trimmer head assembly for accessing grass or weeds located outside of the wheel path. More specifically, the trimmer head position is easily adjustable by the operator without moving from an operational position or stopping the engine. Still another feature of the present trimmer is a bevel mechanism for adjusting the angle of the wheels relative to the frame for achieving different angular positions of the cutting head for trimming closer to a substrate and achieving an even cut appearance. In this manner, the present trimmer head is optionally placed at a desired angle for enhanced edging or cutting along sidewalks, driveways or the like. Also featured is an improved throttle control, which is ergonomically designed to interface with a handlebar, requiring reduced operator force for throttle actuation.

More specifically, a wheeled string trimmer mower is provided, including a trimmer head with a trimmer head housing having a string retention portion and a coupler portion rotatably attached to the string retention portion, the string retention portion having a first string retainer for releasably retaining a first cutting string. In addition, the string retention portion has a second string retainer for releasably retaining a second cutting string. The second string retainer is preferably circumferentially displaced on the string retention portion from the first string retainer.

In a preferred embodiment, the first string retainer has a slidable clamp disposed in the interior and accessible from the exterior. The clamp is constructed and arranged for sliding relative to the base between a clamping position for selectively retaining the string in place in the string retention portion, and a release position for user replacement of the first cutting strings without tools. This clamping position is maintained through centrifugal force generated by rotation of the cutting head which acts on the slidable clamp, gripping the string until released under user control.

In another embodiment, a rotary string trimmer is provided, including a pivoting trimmer head mechanism for trimming outside of the wheel path. This mechanism includes a frame having a pair of wheels and a platform. A trimmer head assembly is mounted on the platform, including an engine, a workhead, and a powertrain connecting the trimmer head to the engine. A feature of the present trimmer mower is that the trimmer head assembly is rotatable relative to the frame between a plurality of indexed angular positions for enabling adjustment of an operational cutting zone of the trimmer head.

Another embodiment of the invention provides a bevel mechanism for a rotary string trimmer mower, including a bevel release lever for adjusting the frame to a plurality of different angular positions. The bevel release lever is connected to the frame and to an adjustable axle associated with one of the wheels. Movement of the bevel release lever relative to the frame adjusts a position of the axle, such that an axis of a first wheel is displaced from an axis of a second wheel, adjusting the first wheel vertically relative to the second wheel and orienting the trimmer head from a parallel position relative to a substrate, to a selected non-parallel position relative to the substrate.

In still another embodiment, a rotary string trimmer mower is provided, including a throttle control for mounting to a handlebar. Included on the throttle control is a paddle coupled between a first throttle control cover and a second throttle control cover, a throttle cable having a first end connected to the first throttle control cover, and a second end connected to a powertrain, and a lever return spring captured inside the throttle control housing. Rotation of the paddle pushes the cable to overcome the biasing force of the return spring, actuating the throttle control.

### BRIEF DESCRIPTION OF THE DRAWINGS

FIG. 1 is a top perspective view of the present trimmer in a standard mowing position;

FIG. 2 is a top plan view of the present trimmer of FIG. 1;

FIG. 3 is a top perspective view of the present trimmer in a first trimmer head pivoted position;

FIG. 4 is a top plan view of the present trimmer of FIG. 3;

FIG. 5 is a top perspective view of the present trimmer in a second trimmer head pivoted position;

FIG. 6 is a top plan view of the present trimmer of FIG. 5;

FIG. 7 is a fragmentary side view of the present trimmer;

FIG. 8 is a fragmentary enlarged side view of the trimmer of FIG. 7;

FIG. 9 is a fragmentary top perspective view of the present trimmer frame in a straight mowing position;

FIG. 10 is a fragmentary top perspective view of the present trimmer frame in a pivoted position;

FIG. 11 is a fragmentary side perspective of the present trimmer showing the bevel mechanism;

FIG. 12 is a fragmentary side perspective of the trimmer of FIG. 11 with the wheel removed;

FIG. 13 is a fragmentary side perspective of the trimmer of FIG. 11 with the wheel removed and in a first bevel position;

FIG. 14 is a side perspective view of the present trimmer in a pivoted, level trimmer head position;

FIG. 15 is a front view of the trimmer of FIG. 14;

FIG. 16 is a fragmentary side perspective of the present trimmer with the wheel removed and in a second bevel position;

FIG. 17 is a side perspective view of the present trimmer in a pivoted, second bevel position;

FIG. 18 is a front view of the trimmer of FIG. 17;

FIG. 19 is a fragmentary side perspective of the present trimmer with the wheel removed and in a third bevel position;

FIG. 20 is a side perspective view of the present trimmer in a third bevel position;

FIG. 21 is a front view of the trimmer of FIG. 20;

FIG. 22 is a top perspective view of the present trimmer head with narrow gauge trimmer strings held by a narrow string retainer;

FIG. 23 is a top perspective view of the present trimmer head with larger gauge trimmer strings held by a large string retainer separate from the narrow retainer;

FIG. 24 is a fragmentary top view of the head with the narrow string retainer;

FIG. 25 is a fragmentary bottom view of the narrow string retainer, including a slidable locking member;

FIG. 26 is a bottom perspective view of the retainer of FIG. 25 with a string attached;

FIG. 27 is a bottom view of the retainer of FIG. 26 showing the direction of string movement when the head is operationally rotated;

FIG. 28 is a side perspective view of the present trimmer head with narrow strings showing the direction of movement of strings under rotational load;

FIG. 29 is a fragmentary top perspective view of the present trimmer head with narrow strings showing the direction of movement of strings under rotational load;

FIG. 30 is top perspective view of the present trimmer head with large gauge strings in the respective retainer, showing the strings under rotational load;

FIG. 31 is a rear perspective view of the present trimmer with the throttle control mechanism;

FIG. 32 is an enlarged fragmentary rear perspective of FIG. 31 showing the throttle control mechanism;

FIG. 33 is a rear perspective view of the present trimmer with the throttle control in an actuated position;

FIG. 34 is an enlarged fragmentary rear perspective of FIG. 33 showing the throttle control in an actuated position;

FIG. 35 is a rear perspective view of the present trimmer with the throttle control in an idle position;

FIG. 36 is an exploded perspective view of the throttle control shown in FIG. 35;

FIG. 37 is a top perspective view of the present throttle control in an idle position;

FIG. 38 is a fragmentary top perspective view of the throttle control of FIG. 37;

FIG. 39 is a front view of the inside of the throttle control cover showing the spring in a relaxed position;

FIG. 40 is an enlarged top perspective view of the throttle control of FIG. 38 in an idle position;

FIG. 41 is a front view of the inside of the throttle control cover showing the spring in a tensioned position;

FIG. 42 is a fragmentary top perspective of the present throttle control in the actuated position;

FIG. 43 is a top perspective view of the present trimmer equipped with the present blower attachment

FIG. 44 is a top plan view of the trimmer of FIG. 43;

FIG. 45 is a top perspective view of the trimmer of FIG. 43 in a first pivoted position;

FIG. 46 is a top plan view of the trimmer of FIG. 45;

FIG. 47 is a top perspective view of the trimmer of FIG. 43 in a second pivoted position;

FIG. 48 is a top plan view of the trimmer of FIG. 47;

FIGS. 49a-d are side elevations of the present blower attachment;

FIG. 50 is an exploded perspective view of the present trimmer with the blower attachment shown detached; and

FIGS. 51a-c are front views of the trimmer of FIG. 43 in various bevel adjustment positions, showing the variation in blower outlet position.

### DETAILED DESCRIPTION

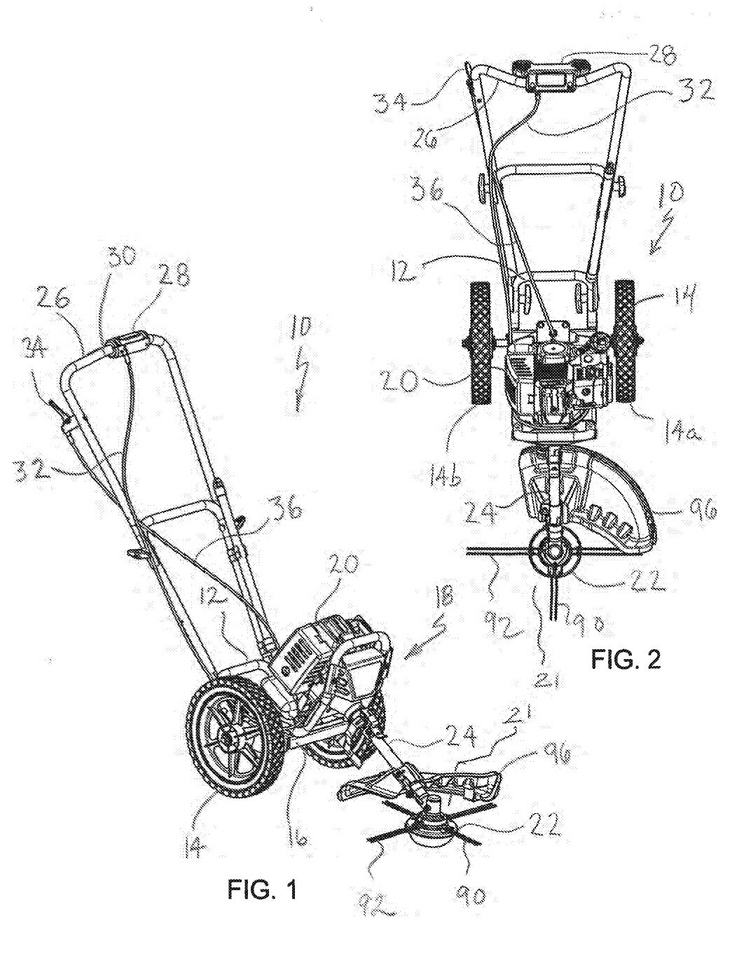

As shown in FIGS. 1 and 2, a preferred embodiment of the present wheeled string trimmer, generally designated 10, includes a frame 12 and a pair of wheels 14 rotatably connected to the frame. A platform 16 is a component of the frame 12 between the wheels 14. An important feature of the present trimmer 10 is that a trimmer head assembly 18 is rotatably mounted on the platform 16. Included with the trimmer head assembly 18 is an engine 20, typically an internal combustion engine, however other power sources, such as rechargeable electric motors, are contemplated. A workhead, 21 such as a rotating trimmer head 22 is connected to the engine 20 via a powertrain or driveshaft 24 as is well known in the art. A handlebar 26 is connected to the frame 12 and includes a throttle control 28 preferably secured to a gripping portion 30. As is known in the art, a throttle cable 32 connects the throttle control 28 to the engine 20.

The above-identified rotatability of the trimmer head assembly 18 is achieved in part through an operator-actuated lever 34 mounted on the handle bar 26, and connected to the trimmer head assembly 18 via a Bowden cable 36 or the like. As discussed below in greater detail, the trimmer head assembly 18 is rotatable relative to the frame 12 between a plurality of indexed angular positions for enabling adjustment of an operational cutting zone of the trimmer head 22.

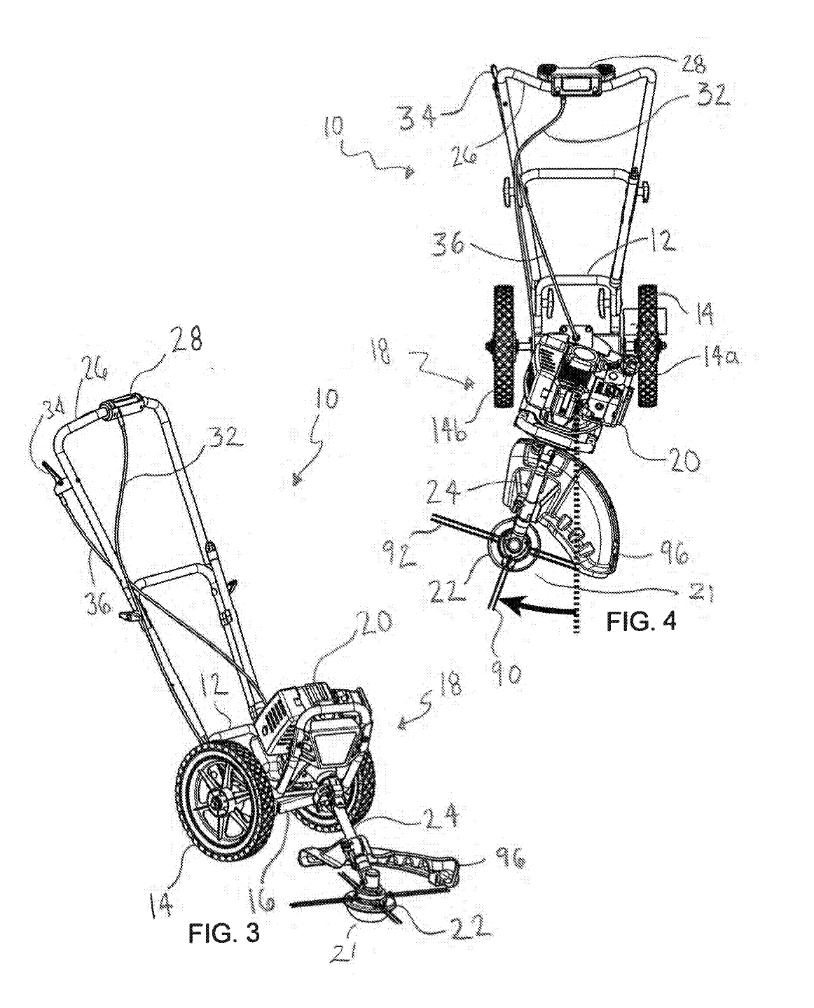

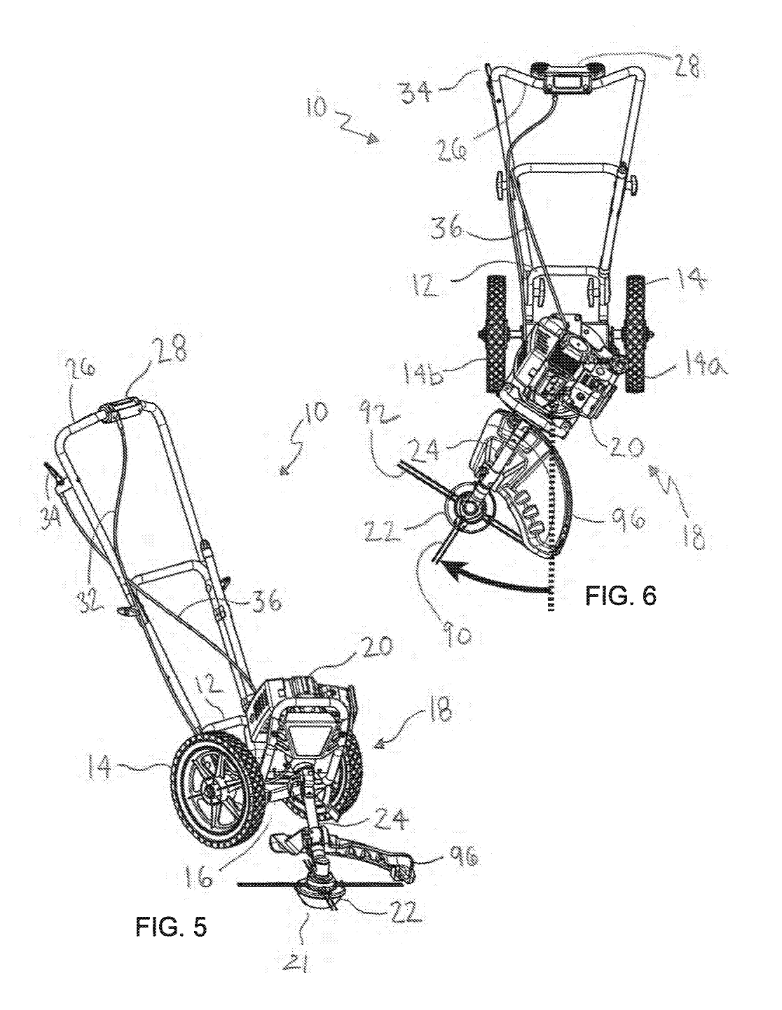

Referring now to FIGS. 1-6, the trimmer 10 is adjustable under operator control so that the trimmer head assembly 18 is movable between a plurality of angular positions including a first position (FIGS. 1-2) wherein the trimmer head 22 is centered on an axis “A” projecting forwardly of the frame 12, a second position (FIGS. 3-4), such that the trimmer head is offset from the axis “A” of the frame at a first angle α, and a third position (FIGS. 5-6), such that the trimmer head is further offset from the axis at a second angle θ larger the first angle. While the size of angles α and β may vary to suit the application, in the preferred embodiment, they are oblique, and more preferably are acute.

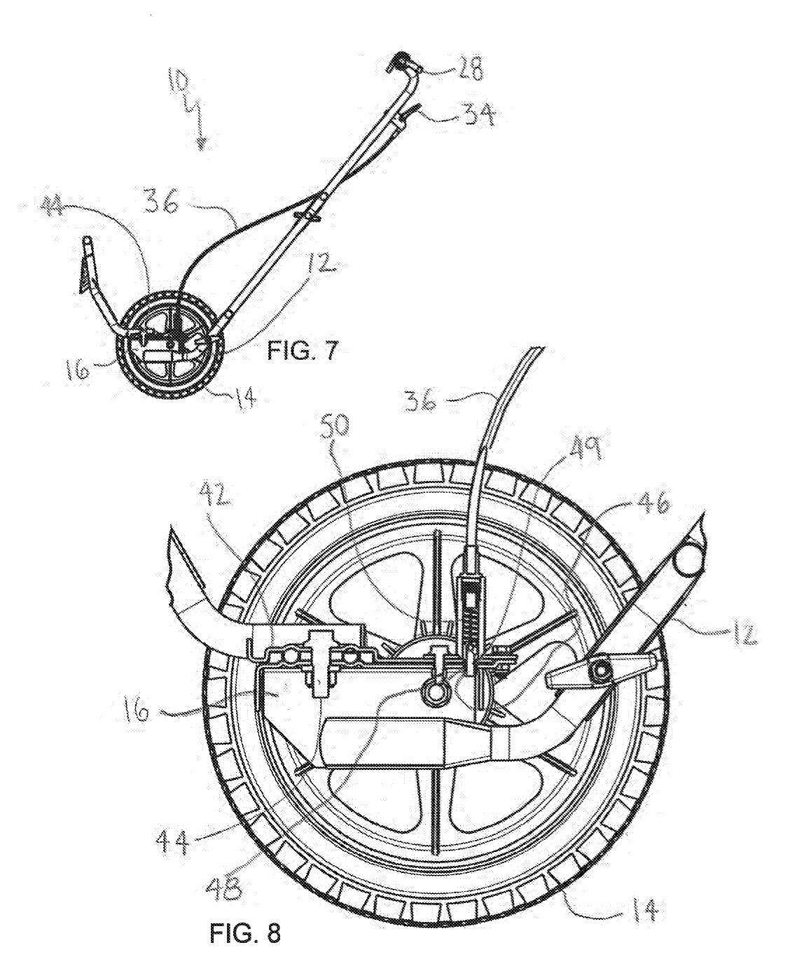

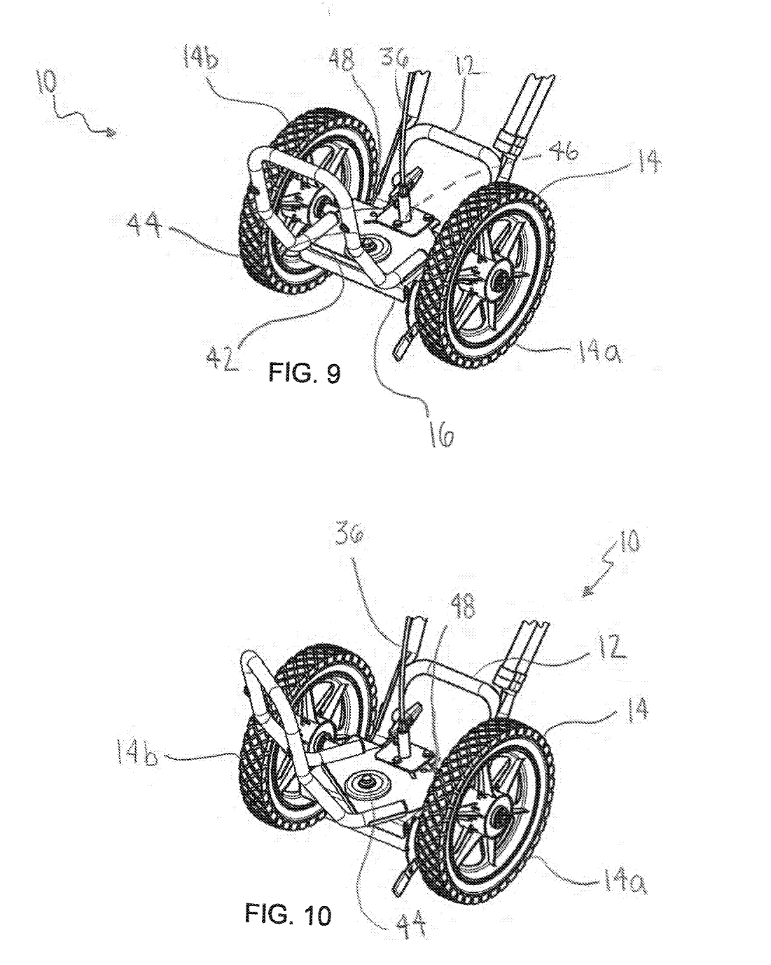

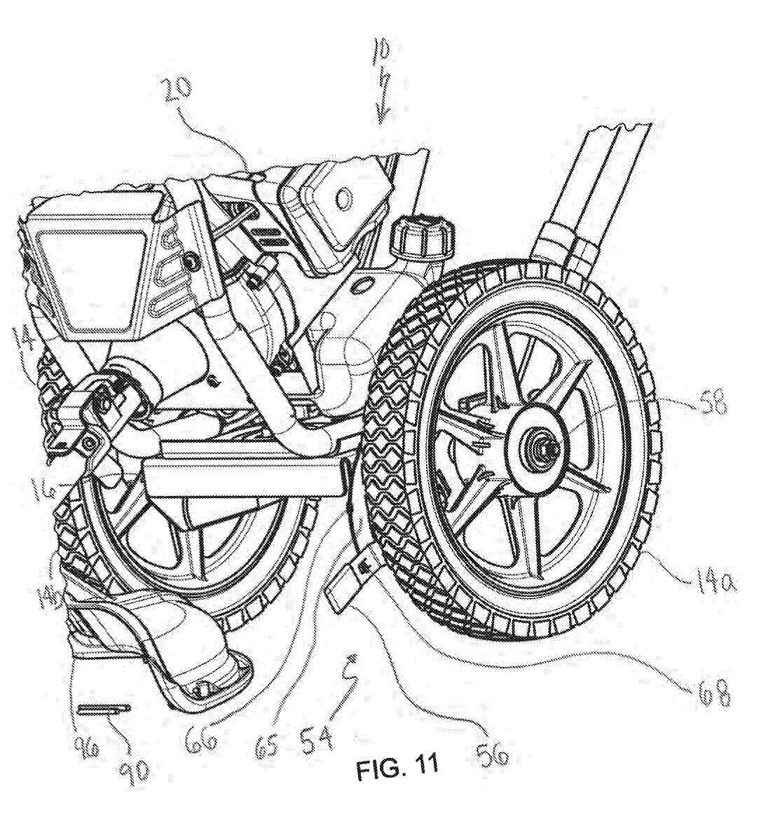

As shown in FIGS. 7-10, the trimmer head assembly 18 further includes a rotating engine bracket 42 mounted to the platform 16 using a pivot pin or bolt 44. A spring-biased locking pin 46 is mounted to platform 16, and is configured for releasably securing the bracket 42 in one of the desired positions through operator control of the actuator lever 34. A plurality of holes 48 is located on the rotating engine bracket 42 in an arc, each hole being in selective alignment with the locking pin 46 and a corresponding hole 49 in the platform 16 for retaining the various positions of the trimmer head assembly 18 relative to the frame 12.

In operation, when the operator desires to change the position of the trimmer head assembly 18 relative to the frame 12, the lever 34 is pulled, which, through the Bowden cable 36, retracts the locking pin 46 by overcoming biasing force generated by a biasing element 50. The biasing element 50 retains the pin 46 in a default locking position. Retraction of the locking pin 46 from the holes 48 and 49 allows adjustment of the trimmer head assembly 18 relative to the frame.

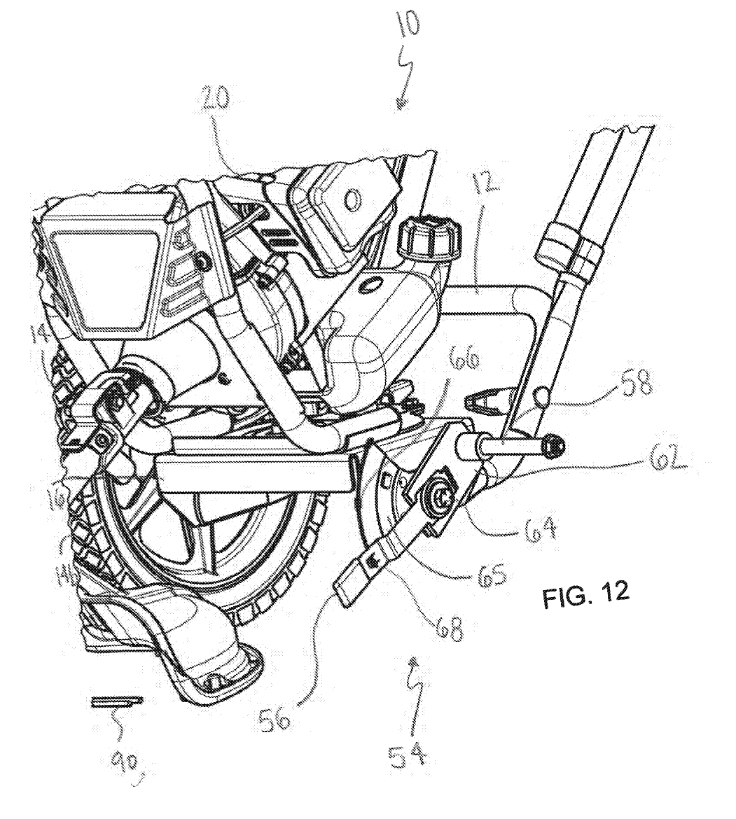

Referring now to FIGS. 11 and 12, another feature of the present wheeled string trimmer 10 is a bevel lever mechanism 54 which is constructed and arranged for enabling adjustment of an angle of attack of the trimmer head 22 to the grass or plants for enhanced edging cutting action. More specifically, a bevel release lever 56 is connected to the frame 12 and to an adjustable axle 58 associated with each of the wheels 14. Pivotal movement of the bevel lever 56 relative to the frame 12 adjusts a position of the axle 58, such that an axis “T” of a first wheel 14a is displaced from an axis “V” of a second wheel 14b. The bevel mechanism 54 further includes a bevel bracket 62 fixed to the frame 12 that releasably receives the bevel lever 56 in a locking relationship, such that the bevel lever and the adjustable axle 58 move relative to the bevel bracket about a pivot pin or bolt 64. An index bracket 65 on the frame 12 has at least one bevel tab 66 and the bevel lever 56 has a complementary bevel slot 68 releasably accommodating one of the tabs 66 for adjusting the position of the axle 58 relative to the frame 12. It is contemplated that, depending on the application, the position of the tab 66 and slot 68 are reversible on the respective lever 56 and bracket 65.

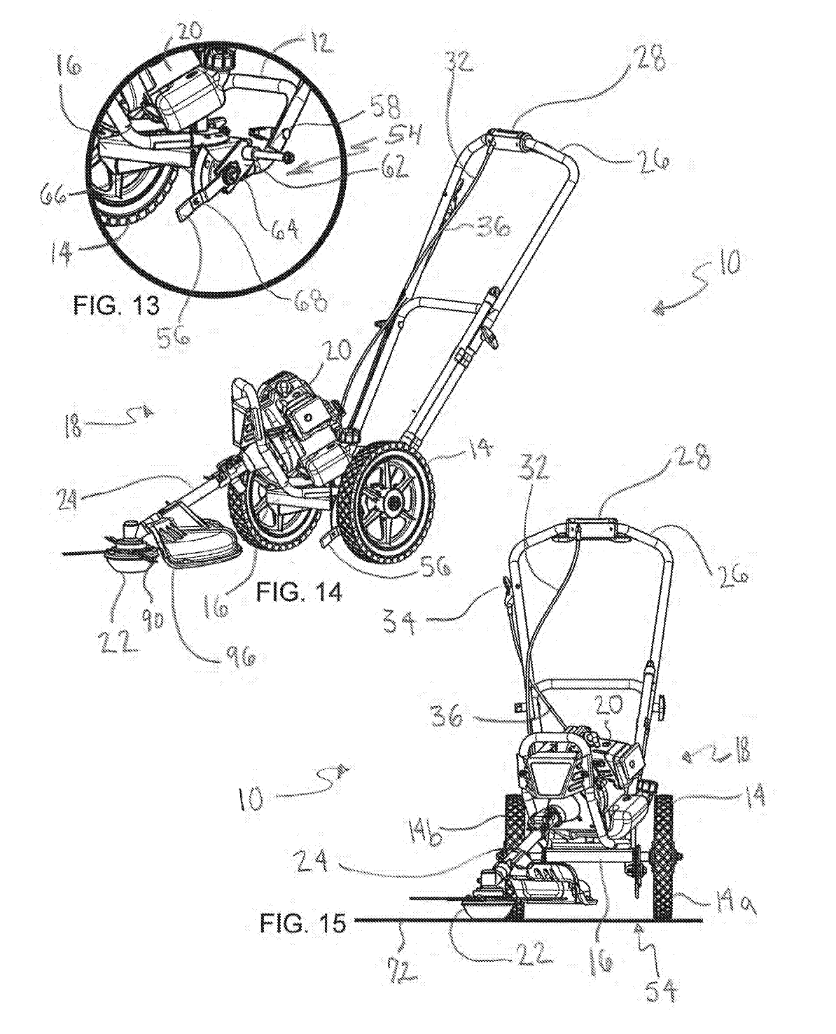

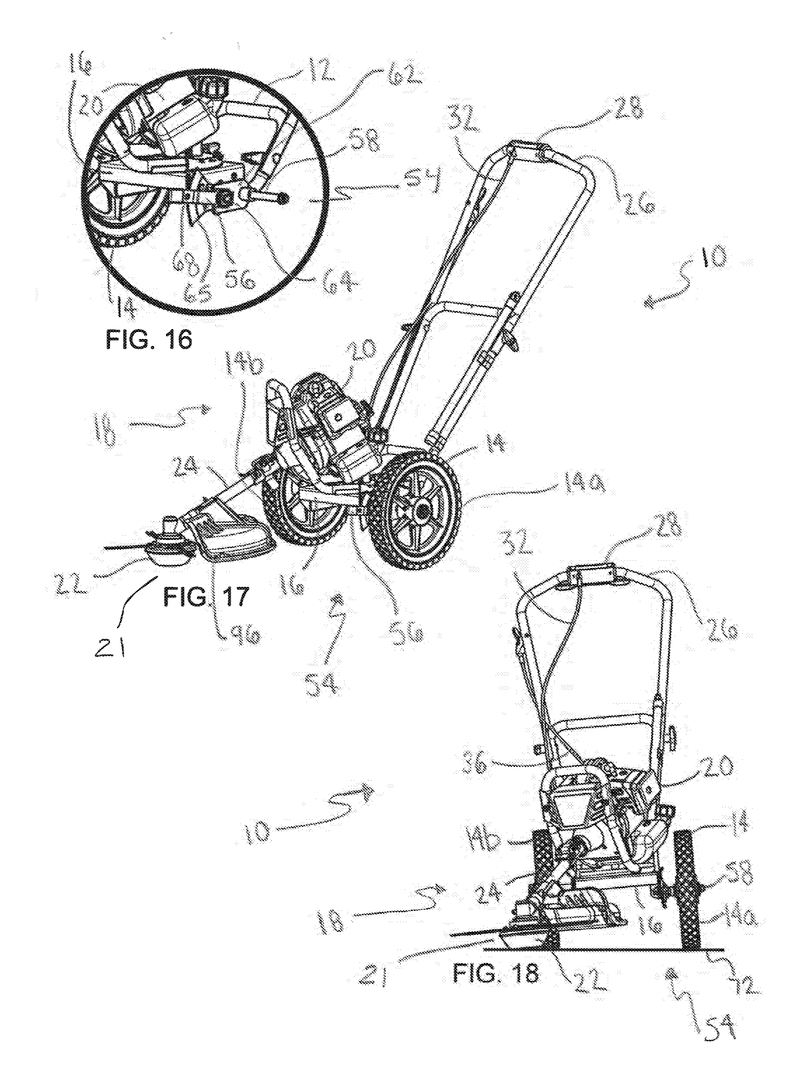

Turning now to FIGS. 13-15, the present string trimmer 10 is shown in a pivoted trimmer head position and a level first bevel position, such that the trimmer head 22 is parallel relative to a substrate 72.

Referring now to FIGS. 16-18, the present string trimmer 10 is shown in a pivoted trimmer head position and a second bevel position, such that the bevel lever 56 has been raised relative to FIGS. 13-15 and the axle 58 has been lowered relative to the frame 12 to move the wheel 14a relative to the other wheel 14b and orients the trimmer head 22 from a parallel position relative to the substrate 72, to a selected non-parallel position at an angle relative to the substrate.

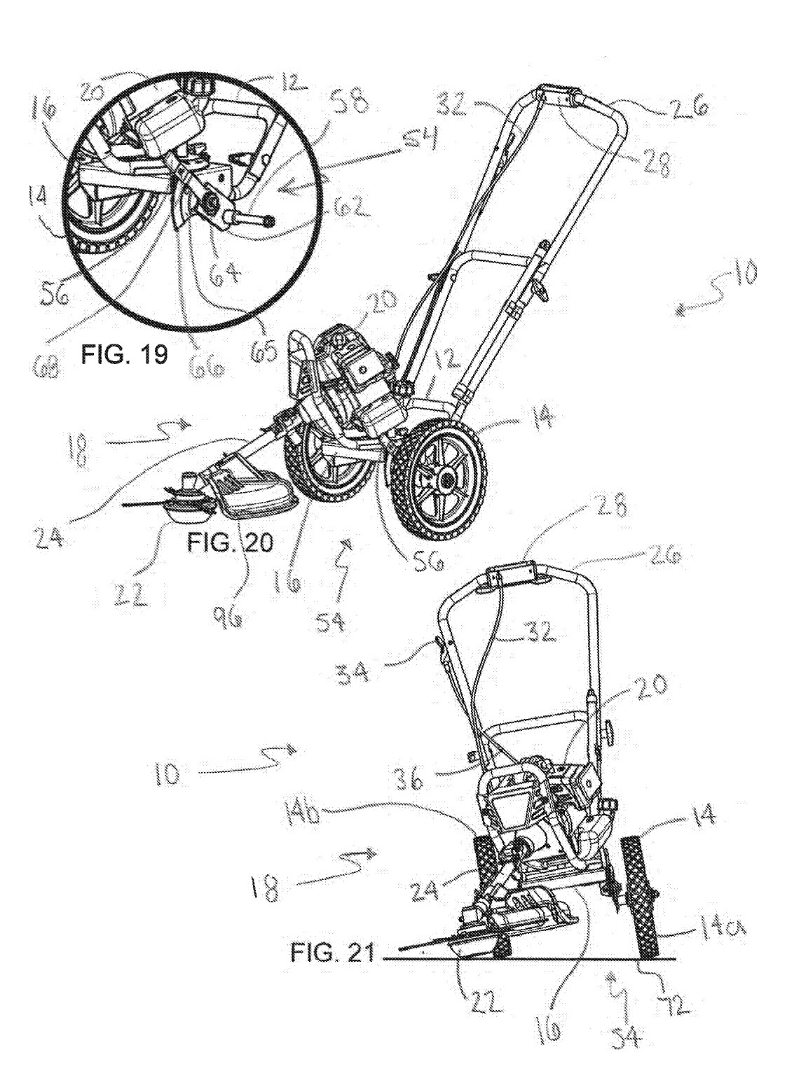

As seen in FIG. 19-21, the present string trimmer 10 is shown in a pivoted head position and a third bevel position, such that the bevel lever 56 adjusts the frame 12 moving one wheel axis vertically relative to the other wheel axis and orients the trimmer head 22 from a parallel position relative to the substrate 72, to a selected non-parallel position Ω relative to the substrate. In the above discussion of the bevel feature, it will be understood that only one wheel 14a was moved relative to the frame 12. However, it is contemplated that the other wheel 14b could easily be moved in a similar manner to achieve desired angular modification of the position of the trimmer head 22.

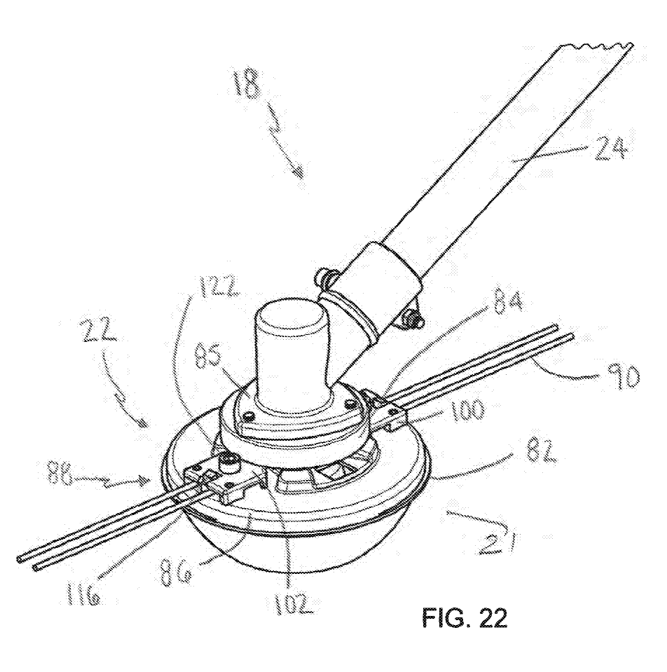

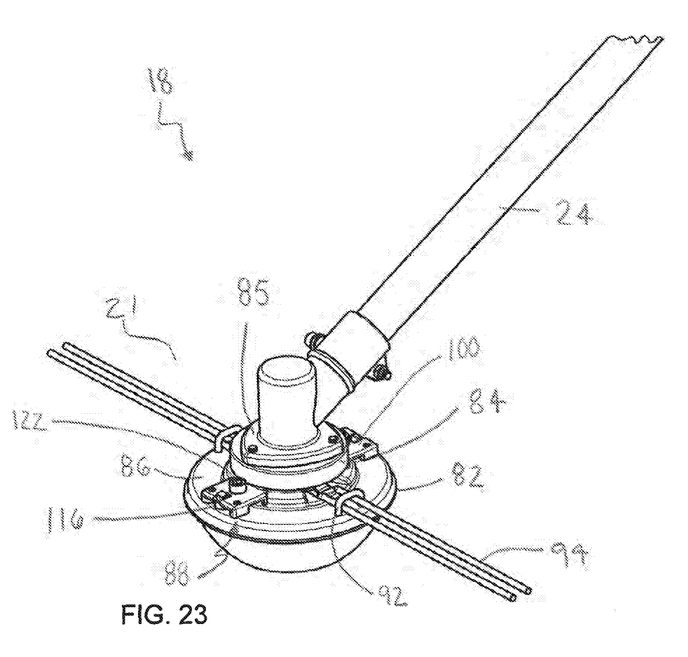

Referring now to FIGS. 22 and 23, another feature of the present wheeled string trimmer 10 relates to a common problem of string trimmers, the retention and replacement of the grass-cutting string. Another common problem of string trimmers is converting operation between various string diameters, including but not limited to 0.095, 0.105 and 0.155 inch diameter string. In the present trimmer 10, this feature is found in the rotatable trimmer head 22 having a trimmer head housing 82 with a coupler portion 84 a string retention portion 86 rotatably attached to the coupler portion. As is known in the art, the coupler portion is secured to an end 85 of the powertrain 24.

The string retention portion 86 has a first string retainer 88 for releasably retaining a first cutting string 90 and a second string retainer 92 for releasably retaining a second cutting string 94. The second string retainer 92 is circumferentially displaced on the string retention portion 86 from the first string retainer 88. Thus, the present trimmer head 22 is configured for accommodating multiple strings 90, 94. Alternatively, an operator has the option of using only one type of string 90, 94 at a time. Also, it is contemplated that the first and second strings 90, 94 will have distinct diameters, and it is preferred that the first string 90 has a smaller diameter (0.095, 0.105 inch), and the second string 94 has a larger diameter (0.155 inch), the latter used for heavier duty operation. The focus of the present trimmer head 22 will be on the retention of the first string 90. As is known in the art, the powertrain 24 is preferably provided with a clippings guard 96 for directing the flow of cut grass and plants.

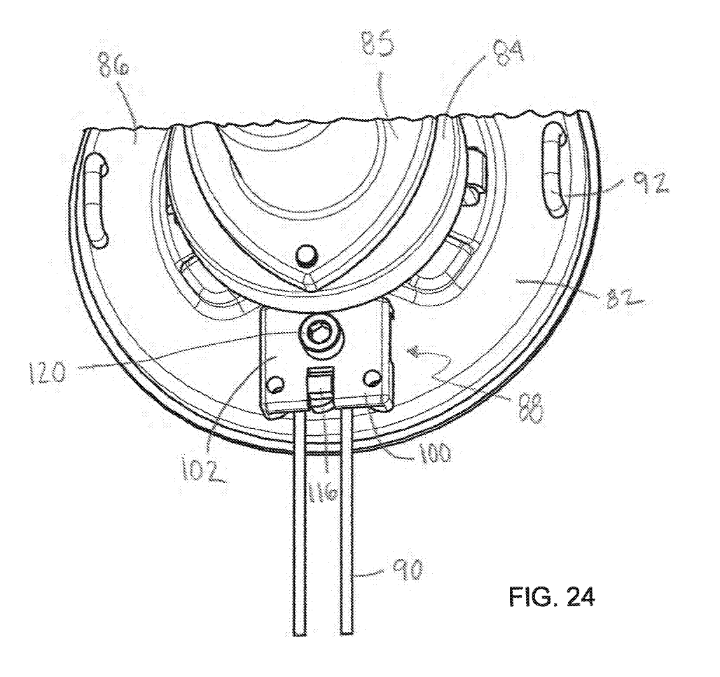

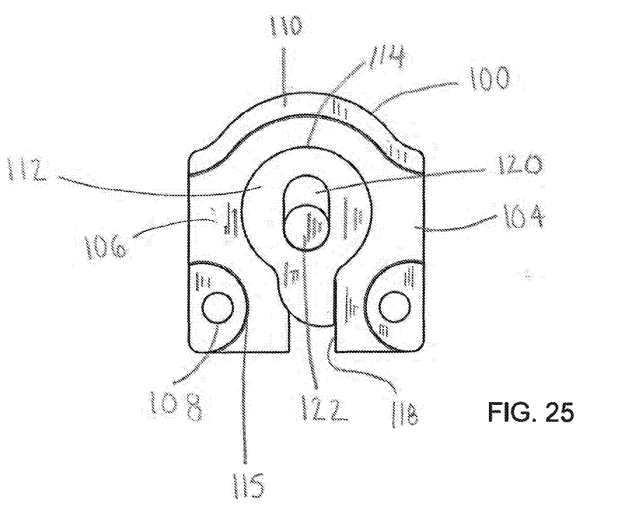

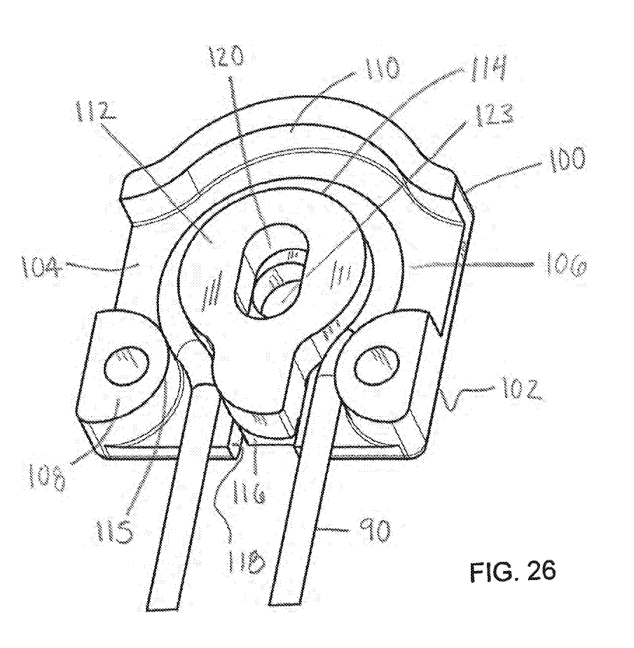

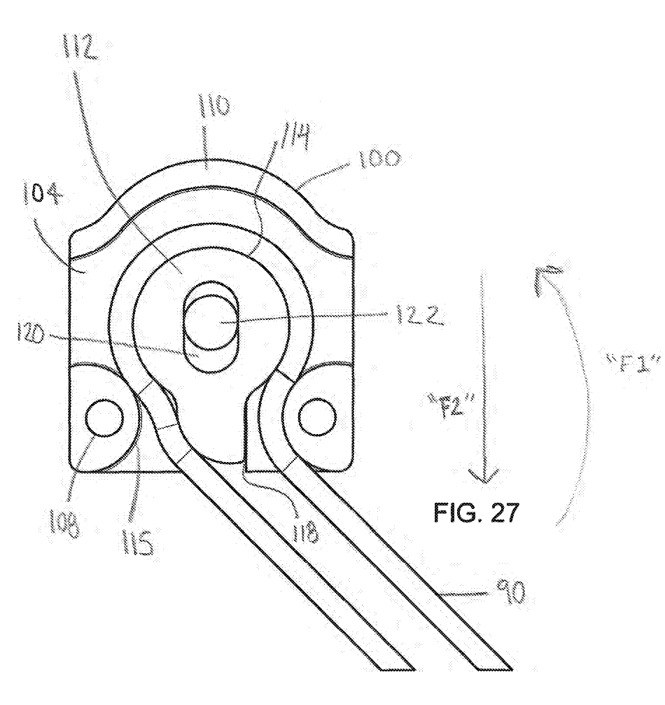

Referring now to FIGS. 22 and 24-27, the first string retainer 88 has a cover 100 with an exterior surface 102 facing the operator during normal operation, and an opposite interior surface 104. The interior surface 104 includes a curved track 106 defined by at least one boss 108 and a preferably curved wall 110. The first cutting string 90 follows the curved track 106 to reduce stress concentration. A slidable clamp 112 is disposed relative to the cover 100 so that it is operationally captured between the cover and the trimmer head housing 82. The clamp 112 is accessible from the exterior surface 102 and slides relative to the cover 100 between a clamping position (FIG. 26) for selectively retaining the first cutting string 90 in place against the bosses 108, and a release position (FIG. 25) where the clamp slides away from the bosses for user replacement of the first cutting string 90 without tools.

The slidable clamp 112 has a peripheral surface 114, such that the clamping position is achieved by a squeezing action exerted on the first cutting string 90 by the peripheral surface against an opposing curved surface 115 of the at least one and preferably both bosses 108.

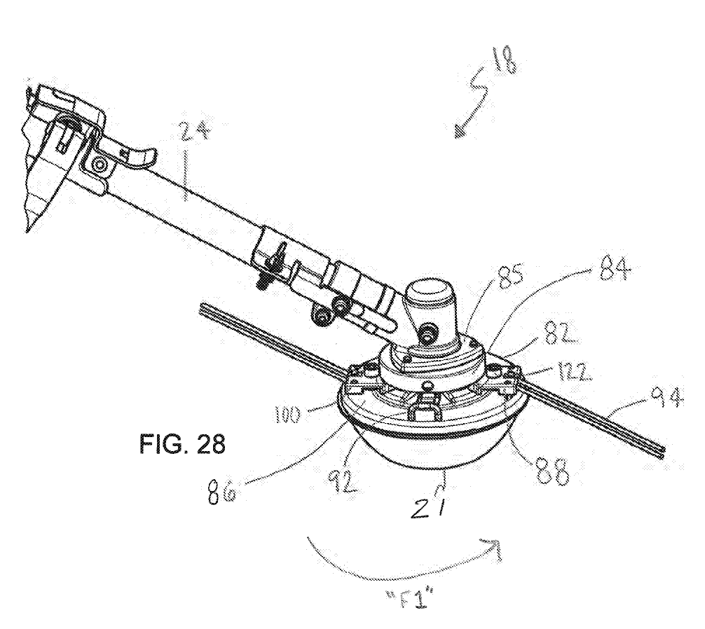

Referring now to FIGS. 26-29, the slidable clamp 112 has a tab 116 that slides reciprocally in a slot 118 in the cover 100 for securing the first cutting string 90 and for allowing the user to move the slideable clamp 112 during string installation for tool-less string replacement. Also included on the clamp 112 is an elongate aperture 120 that receives a fastener 122 such as a bolt or the like that passes through a mounting hole 123 to secure the cover 100 to the trimmer head housing 82, and at the same time retaining the clamp within the cover.

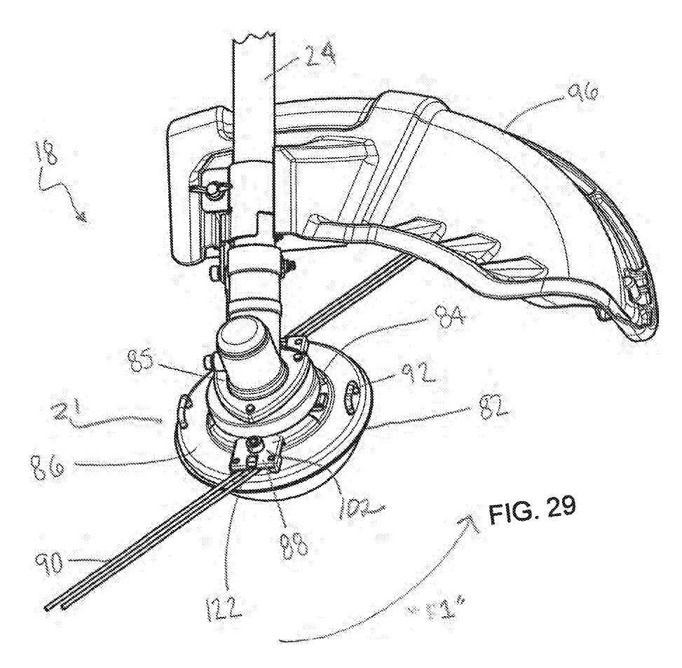

During operation, as the trimmer head 22 rotates relative to the powertrain 24, rotation force “F1” is generated which causes the first string 90 to bend relative to the trimmer head (FIGS. 27 and 29). The bending of the string 90 occurs around the radiused bosses 108 and the radiused feature of slideable clamp 112, thus reducing the stresses in the string. In addition, the centrifugal force “F2” causes the clamp 112 to slide in the slot 118 towards the bosses 108, thus pinching the first string 90 in position and holding the string in the retainer 88.

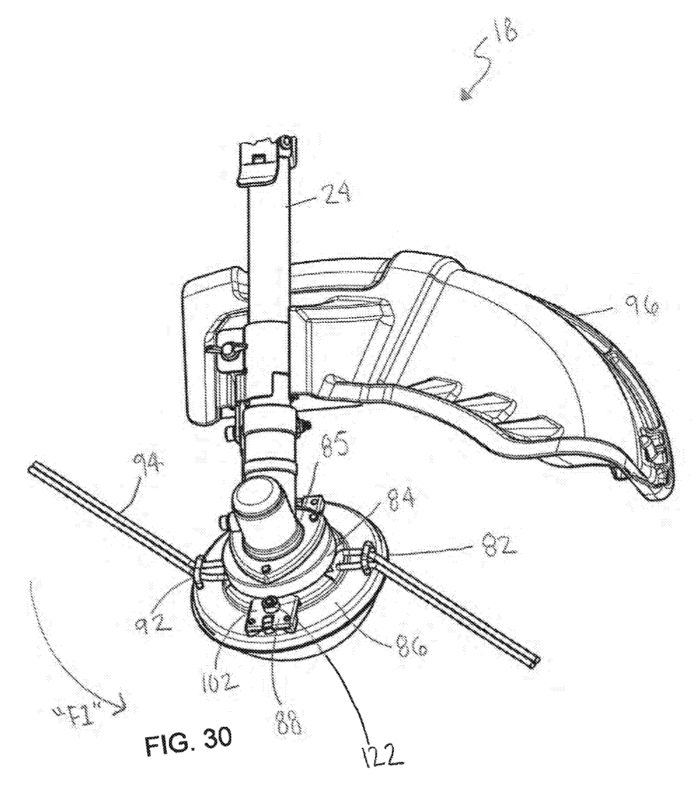

Referring now to FIG. 30, the trimmer head 22 is shown with the second cutting string 94 attached to the second string retainer 92, showing the direction of string movement when the trimmer head 22 is operationally rotated. As is the case with the first string retainer 88, the second string retainer holds a single length of string in a doubled over or looped orientation, which presents two lengths of string to the plants for enhanced cutting action.

As shown in FIGS. 31, 32 and 36, another feature of the present wheeled string trimmer 10 is that the throttle control 28 includes a throttle control housing 126 mounted on the handlebar 26 and having a throttle paddle 128 for actuating the engine 20 for powering the trimmer head 22. The paddle 128 is coupled between a first throttle control cover 130 and a second throttle control cover 132, these latter components defining the throttle control housing 126. In addition, the paddle 128 is affixed to the base of a cylinder casing 134, which rotatably engages the first throttle cover 130, rotating about the handlebar 26.

The throttle control 28 has at least one fastener 140 extending through the second cover 132 into the first cover 130, to both retain the throttle control on the handlebar 26, and also creates a space in which the paddle 128 moves under operator control. More specifically, the first and second covers 130, 132 each have at least one curved raised wall or fin 142 on inside surfaces 144 configured for defining a guiding track, rotatably engaging and complementary ribs 146 on the cylinder casing 134.

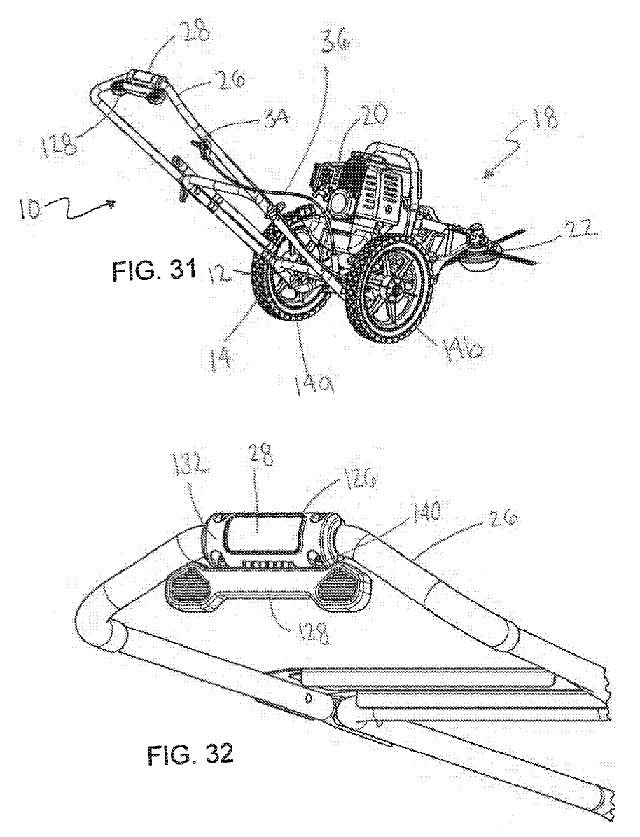

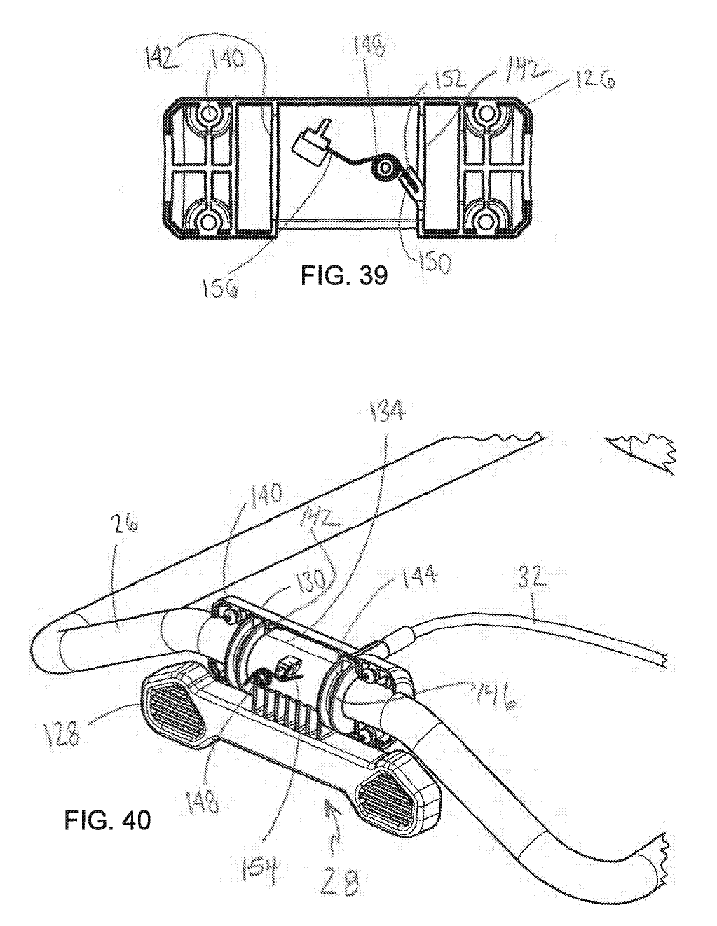

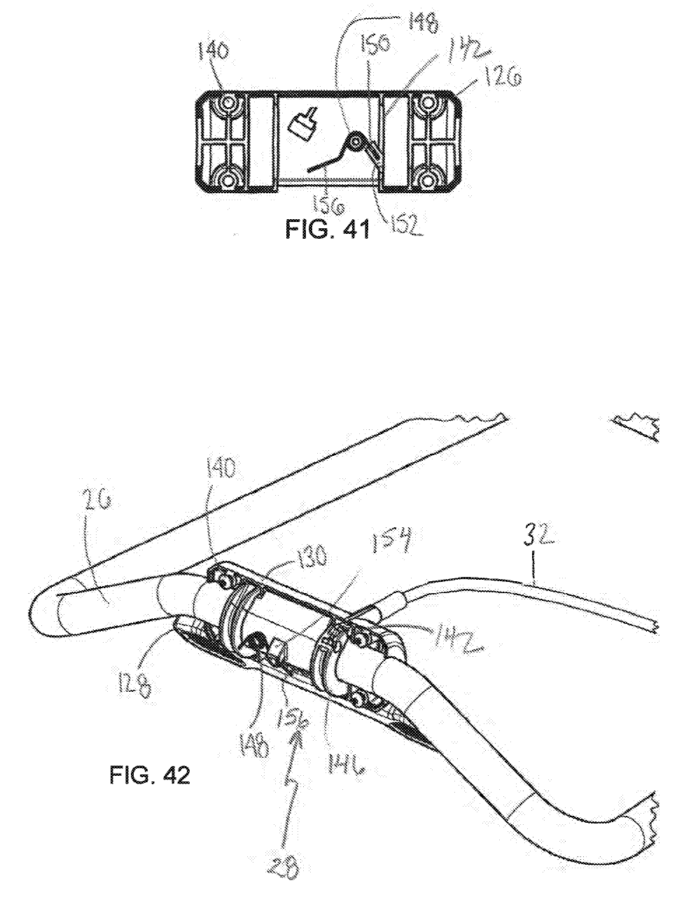

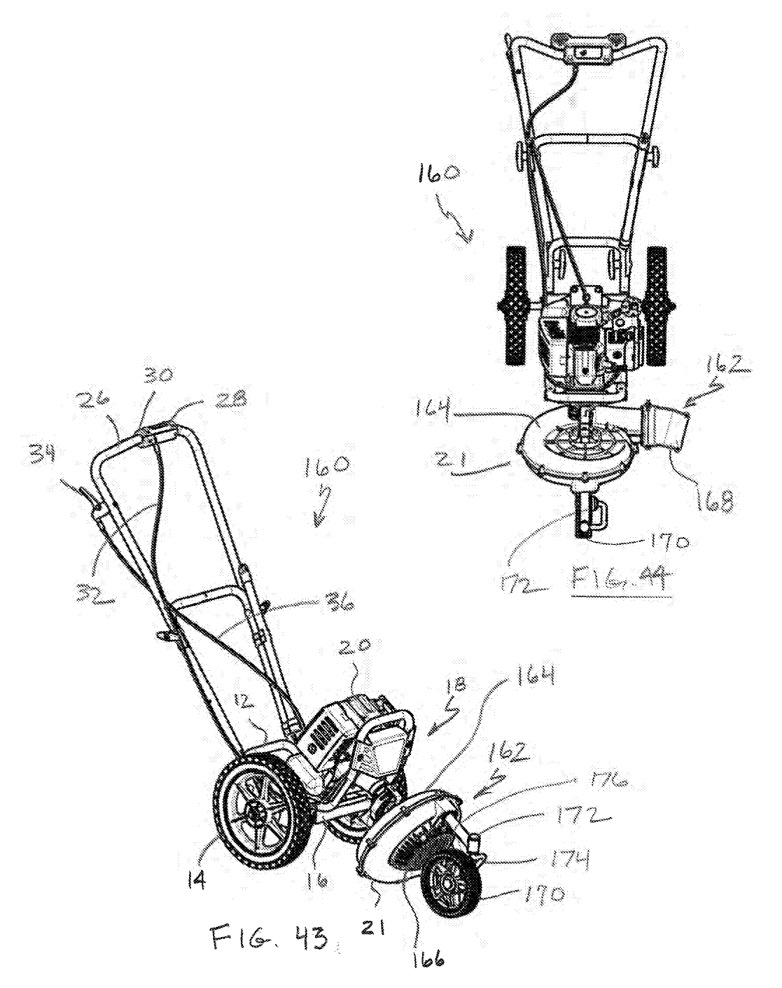

Referring now to FIGS. 36, 38, 39 and 41, a lever return spring 148 is captured inside the throttle control housing 126, preferably on the inside surface 144 of the second throttle control cover 132 by engagement of a short free end 150 of the spring 148 in a socket 152 formed in the cover. Upon assembly of the throttle control housing with the captured paddle cylinder casing 134, a spring actuator formation 154 on the casing engages a long free end 156 of the spring 148. As the user presses on the paddle 128, causing the cylinder casing 134 to rotate in the track formed by the fins 142, the actuator formation 154 tensions the return spring 148. Upon user release of the paddle 128, the return spring 148 is allowed to return to its rest or idle position (FIGS. 32, 38).

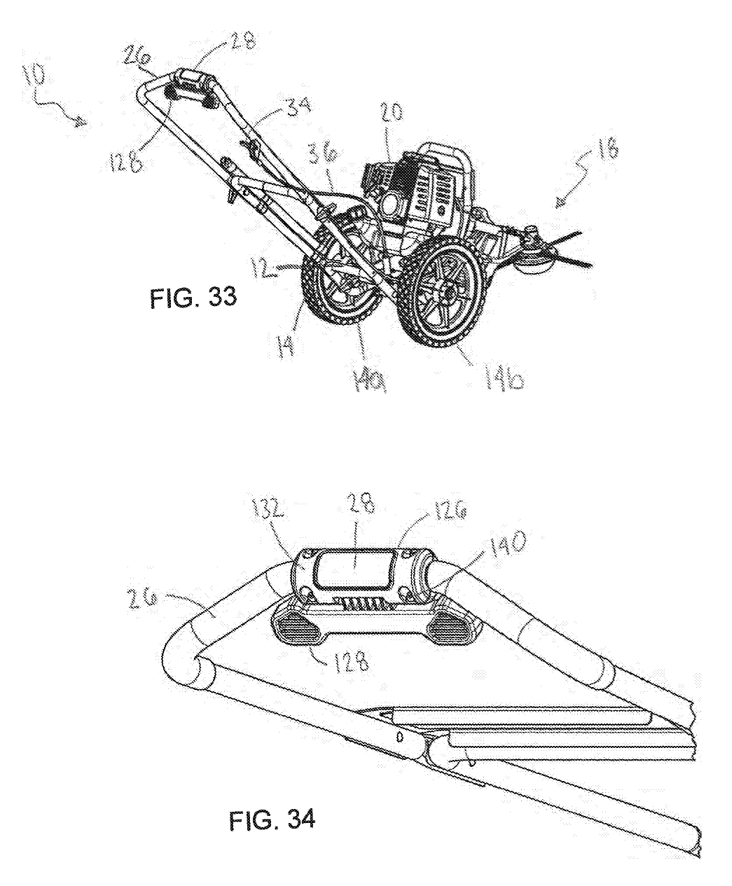

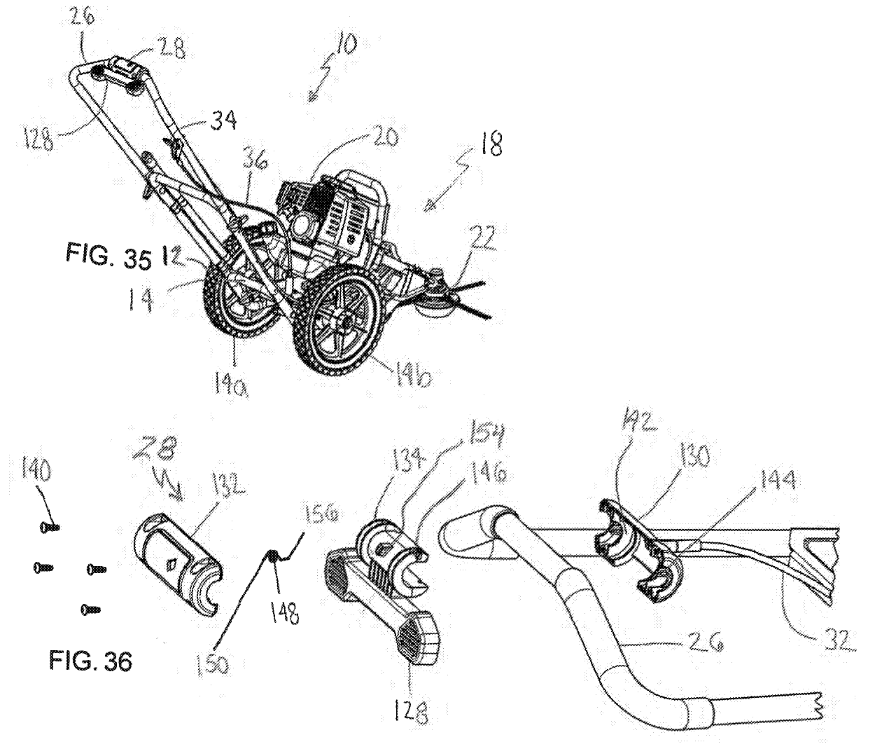

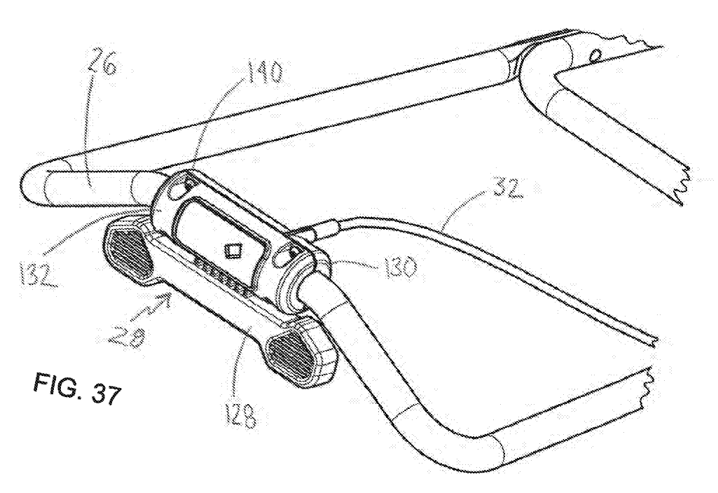

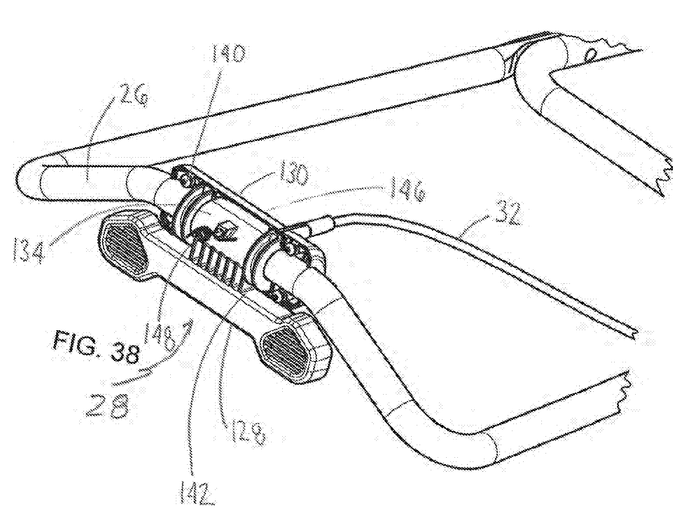

Referring now to FIGS. 33-35 and 37, a feature of the above-described throttle control 28 is that the user can actuate the paddle 128 with either or both thumbs, providing a more ergonomic relationship than seen in conventional trimmers of this type.

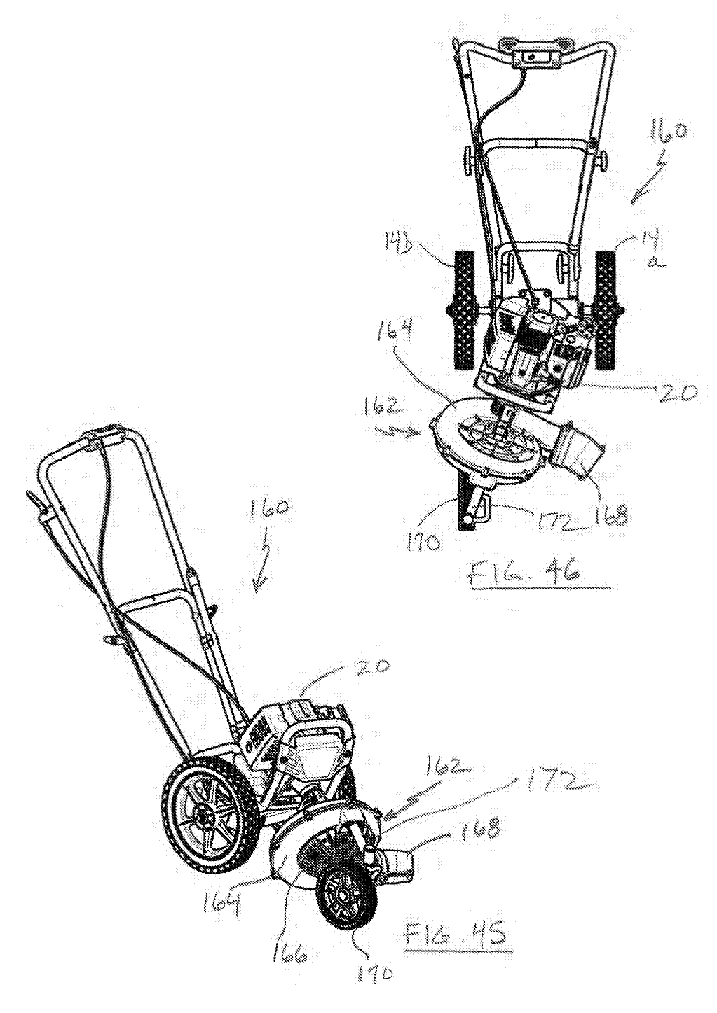

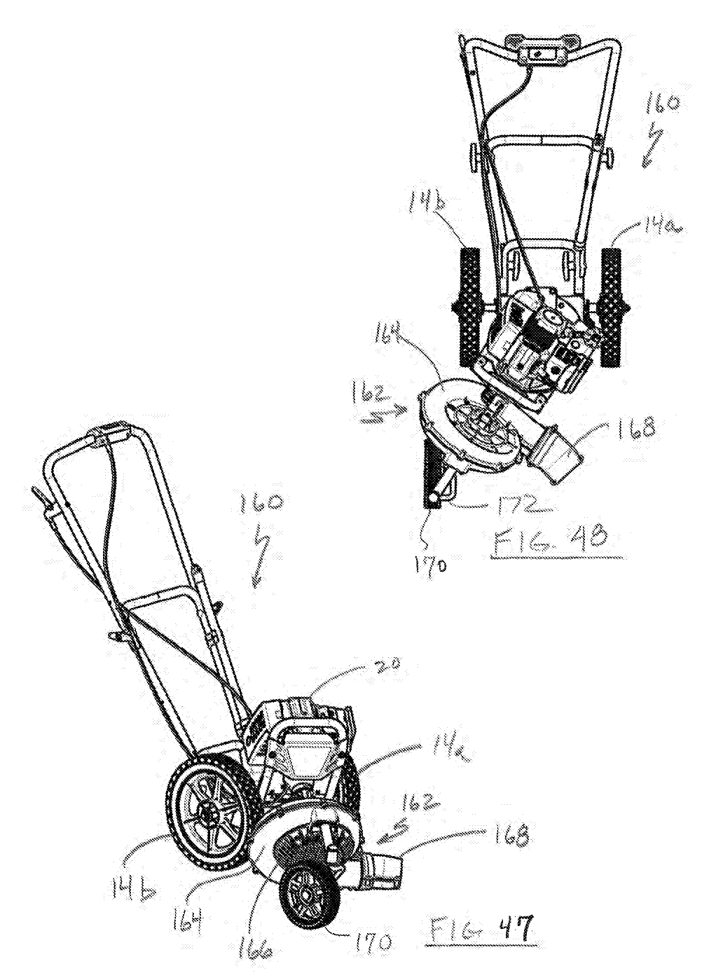

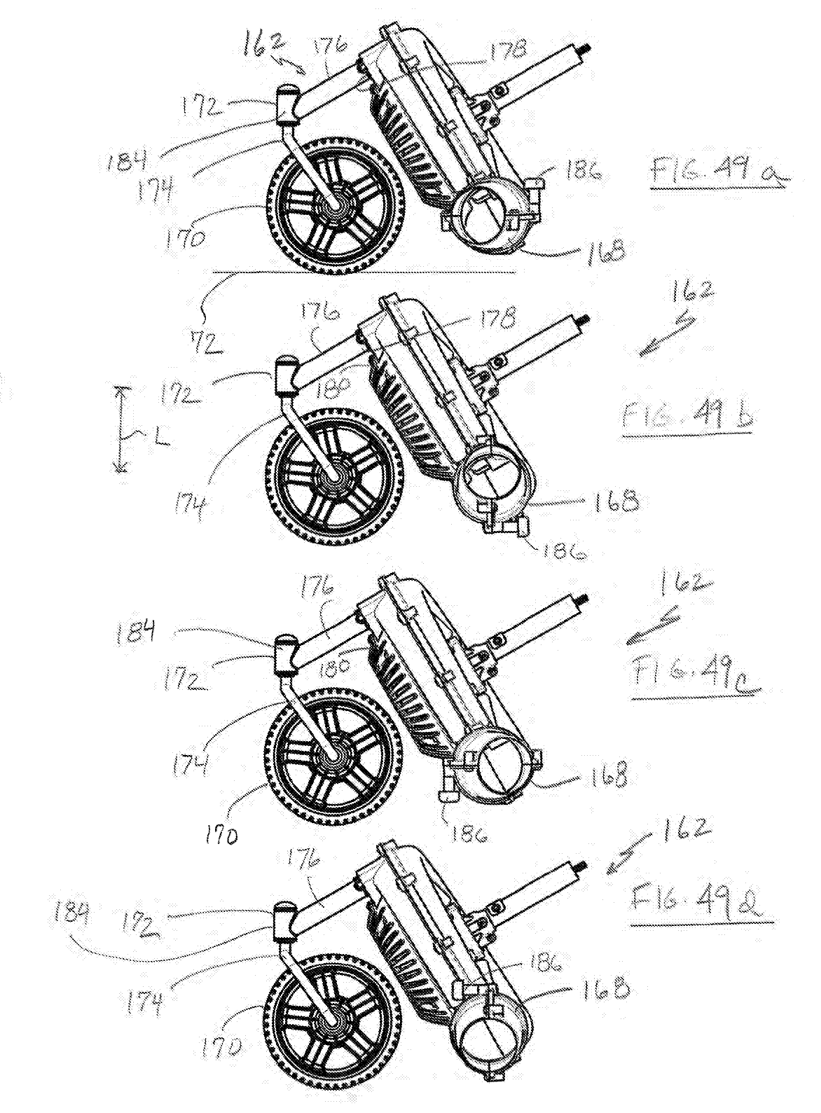

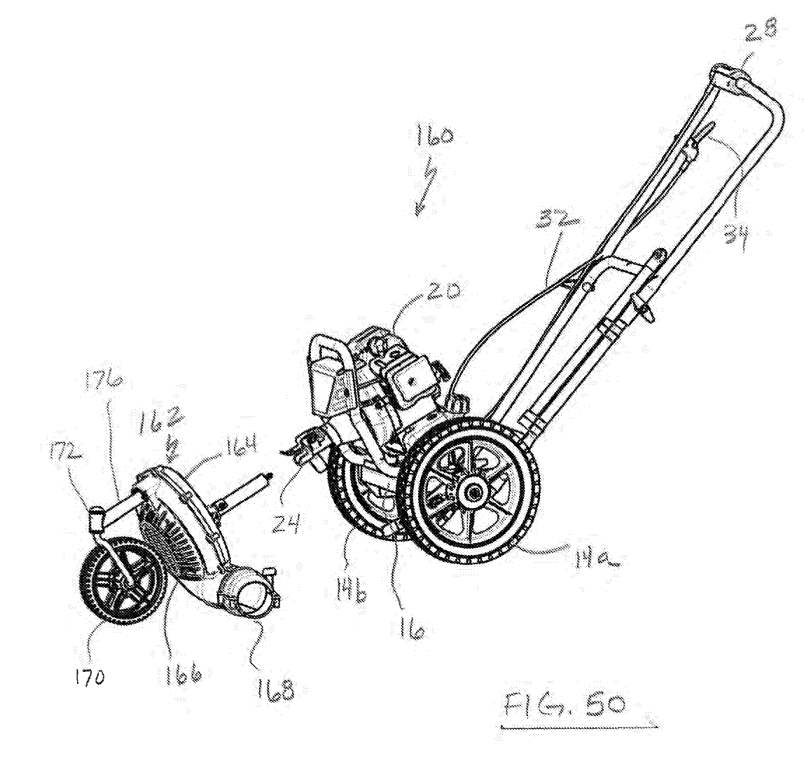

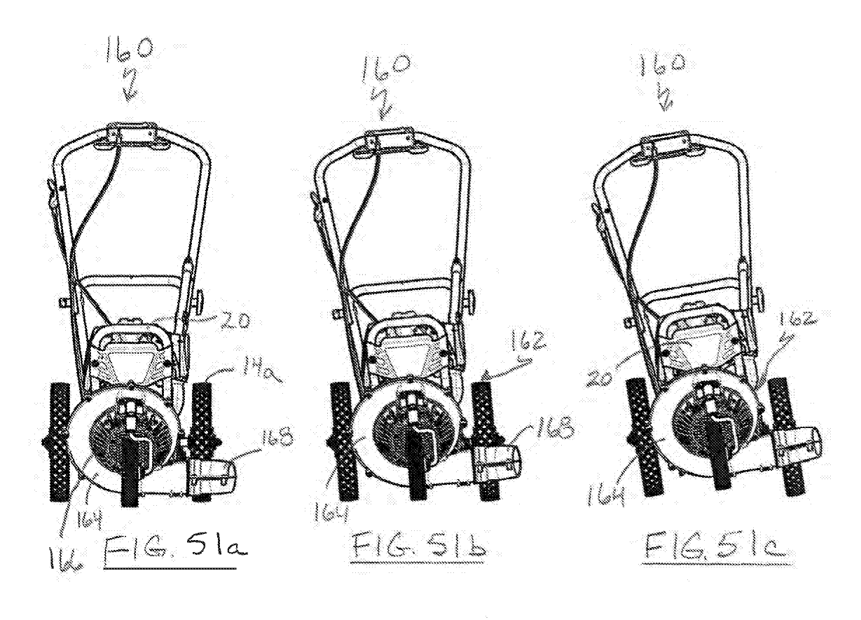

Referring now to FIGS. 43-50, an alternate embodiment of the present trimmer is generally designated 160. Components shared with the trimmer 10 are designated with identical reference numbers. An important distinction of the trimmer 160 is that in the trimmer head assembly 18, the trimmer head 22 is replaced as the workhead 21 by a powered blower assembly, generally designated 162. As is the case with the trimmer head assembly 18, the blower assembly 162 is releasably connected to the driveshaft 24.

A blower housing 164 encloses an impeller (not shown) connected to the driveshaft 24 for common rotation. Air is drawn into the housing 164 via a grille or intake vents 166 and is dispensed at higher velocity through an outlet nozzle 168. A guide wheel 170 is rotatably mounted to a bracket 172 having a first leg 174 disposed generally parallel to a generally vertical axis of the blower housing 164 and which rotatably receives the guide wheel. A second leg 176 of the bracket 172 is generally parallel to the driveshaft 24, so that the two legs 174, 176 together form a general “L”-shape.

Referring now to FIGS. 49a-d, a housing end 178 of the second leg 176 is secured to the blower housing 164 at a front face 180 so that the guide wheel 170 is spaced in front of, and freely rotates relative to, the housing. A benefit of the guide wheel 170 is that the blower housing 164 and the outlet nozzle 168 are maintained above the substrate 72 regardless of the indexed angular position of the trimmer head assembly 18, or as the bevel position is changed.

It will be seen that the first leg 174 of the bracket 172 is provided with a length “L” (FIG. 49b) dimensioned so that the outlet nozzle 168 is suspended above the substrate or ground 72 (FIG. 49a) throughout the operational rotating arc of the engine 20 relative to the platform 16 and the frame 12 in the various indexed angular positions as described above, and as seen in FIGS. 43-48. The first leg 174 is pivotably connected to the second leg 176 at a socket 184 so that the guide wheel 170 assumes a position generally aligned with the wheels 14a, 14b during operation of the trimmer 160, regardless of the position.

Referring again to FIGS. 49a-49d, another feature of the present trimmer 160 is that the outlet nozzle 168 is movable and directable under user control to adjust the direction of high velocity air as needed, depending on the rotated orientation of the blower housing 164, which, as is the case with the trimmer head assembly 18 described above, is a function of the relative indexed angular rotational position of the engine 20 relative to the platform 16 and to the frame 12, or the adjusted bevel position.

To adjust the position of the outlet nozzle 168 relative to the blower housing 164, the user loosens a fastener 186, preferably a thumbscrew or the like, which controls a clamp, which then permits the nozzle 168 to rotatably slide in a designated track (not shown) on the housing. Once the nozzle 168 achieves the desired position, the user tightens the fastener 186. Thus, the user can manipulate the outlet nozzle 168 for directing air flow as needed, and as the trimmer head assembly 18 rotates relative to the frame 12, and as the bevel adjustment is altered.

Referring now to FIGS. 51a-51c, another feature of the present trimmer 160 with the blower attachment 162, is that, depending on the adjusted bevel position, as described above in relation to FIGS. 11-21, the user can employ the bevel position to elevate or lower the blower outlet nozzle 168. In certain operational applications, such as when large piles of leaves or other loose debris need to be moved, this elevation of the blower outlet nozzle 168 can be used to gradually move large volumes of leaves or other debris, by directing the air flow from the top of the pile downwards, or vice versa, as the bevel adjustment is changed.

While a particular embodiment of the present wheeled string trimmer has been described herein, it will be appreciated by those skilled in the art that changes and modifications may be made thereto without departing from the invention in its broader aspects and as set forth in the following claims.

1. A trimmer head for a string trimmer mower, comprising:
a trimmer head housing having a string retention portion and a coupler portion rotatably attached to said string retention portion;
said string retention portion having a first string retainer for releasably retaining a first cutting string; and
said string retention portion having a second string retainer for releasably retaining a second cutting string, said second string retainer is circumferentially displaced on said string retention portion from said first string retainer.

2. The trimmer head of claim 1, wherein said first string retainer has a cover with an exterior surface and an interior surface, said interior surface including a curved track defined by at least one boss and a wall, wherein the first cutting string follows said curved track to reduce stress concentration; and
a slidable clamp disposed in said interior surface and accessible from said exterior surface and being constructed and arranged for sliding relative to the cover between a clamping position for selectively retaining the string in place in said string retention portion and a release position for user replacement of the first cutting string without tools.

3. The trimmer head according to claim 2, wherein said clamp has a peripheral surface, and said cover is provided with at least one boss that partially defines said curved track, wherein said clamping position is achieved by a squeezing action exerted on the first cutting string by said peripheral surface against said at least one boss.

4. The trimmer head of claim 2, wherein said slideable clamp has a tab that slides in a slot in said cover for guiding the string and for user access, such that said slideable clamp is accessible from the exterior of said cover through said tab, allowing the operator to move said slideable clamp during string installation for tool-less string replacement.

5. The trimmer head of claim 2, wherein said trimmer head is configured for accommodating at least three cutting string diameters, said first string retainer is constructed and arranged for releasably retaining at least two cutting string diameters; and said second string retainer is constructed and arranged for releasably retaining a cutting string with a diameter larger than said first string retainer.

6. A rotary string trimmer mower, comprising:
a frame having a pair of wheels mounted thereto, and including a platform;
a trimmer head assembly, including an engine, a workhead, and a powertrain connecting said trimmer head to said engine, said assembly mounted on said platform; and
said trimmer head assembly is rotatable relative to said frame between a plurality of indexed angular positions for enabling adjustment of an operational cutting zone of said trimmer head.

7. The rotary string trimmer mower according to claim 6, wherein said
plurality of angular positions include a first position wherein said trimmer head is centered on an axis projecting forwardly of said frame;
a second position, such that said trimmer head is offset from the axis of said frame at a first angle; and
a third position, such that said trimmer head is further offset from the axis at a second angle larger than said first angle.

8. The rotary string trimmer mower according to claim 6, further including a rotating engine bracket rotatably mounted to said platform; a spring-biased locking pin coupled between said frame and said rotating engine bracket, and is configured for releasably securing said rotating engine bracket to said frame, such that said engine bracket is rotatably affixed to said platform using a pivot point; and wherein a plurality of holes is located on said rotating engine bracket, said holes are in alignment with said locking pin for retaining the various positions of said string trimmer relative to said frame.

9. The rotary string trimmer mower according to claim 8, further including a Bowden cable with a first end fixedly connected to said locking pin and a second end fixedly connected to an operator-actuated lever; and a biasing element is constructed and arranged for biasing said locking pin in a selected one of said plurality of holes, such that said locking pin is disengaged by actuation of said lever.

10. The rotary string trimmer mower according to claim 6, further including a bevel release lever connected to said frame and to an adjustable axle associated with each of said wheels; and wherein movement of said bevel release lever relative to said frame adjusts a position of said axle such that an axis of a first of said wheels is displaced from an axis of a second of said wheels.

11. The string trimmer mower according to claim 10, wherein said bevel lever is constructed and arranged to adjust said frame to a plurality of different angular positions from a cover, horizontally-oriented position, such that said adjustment moves one said wheel vertically relative to the other said wheel and orients said trimmer head from a parallel position relative to a substrate, to a selected non-parallel position relative to the substrate.

12. The rotary string trimmer mower according to claim 10, further including a bevel bracket on said frame that releasably receives said bevel lever in a locking relationship, wherein said lever and said adjustable axle move relative to said bevel bracket.

13. The rotary string trimmer mower of claim 12 wherein said bevel bracket having at least one tab and said lever having a complementary slot accommodating one of said tabs for adjusting the position of said axle relative to said frame.

14. The rotary string trimmer mower of claim 6 wherein said workhead is one of a trimmer head and a blower attachment.

15. The rotary string trimmer mower of claim 14, wherein said workhead is said blower attachment, and includes a blower housing with an outlet nozzle, and provided with a guide wheel projecting from said housing for maintaining said nozzle above a substrate regardless of said indexed angular position of said trimmer head assembly.

16. The rotary string trimmer mower of claim 15, further including a bracket connecting said guide wheel to said blower housing, said bracket including a first leg and a second leg, forming a general “L”-shape.

17. A throttle control for a rotary string trimmer mower with a handlebar, comprising:
a throttle control housing configured for mounting to the handlebar, having a throttle paddle coupled between a first throttle control cover and a second throttle control cover;
a throttle cable having a first end connected to said first throttle control cover, and a second end connected to a powertrain; and
a lever return spring captured inside said throttle control housing, such that the rotation of said paddle pushes said cable to overcome the biasing force of said return spring, actuating said throttle control.

18. The throttle control housing according to claim 17 wherein said throttle paddle is affixed to the base of a cylinder casing; and
wherein said cylinder casing rotatably engages said throttle cover, rotating about the handlebar, such that at least one fastener extends through said second throttle control cover into said first control cover, a raised wall on the inside of said first throttle cover defines a guiding track rotatably securing said cylinder casing to the handlebar.

19. The throttle control according to claim 17 wherein said throttle paddle controls the engine speed under operator control, with one or both thumbs, such that the removal of operator input returns the engine to an idle speed; and wherein said return spring is relaxed when in idle position and tensioned when said paddle is rotated by the operator, actuating said throttle control.
